(19) United States
(12) Patent Application Publication
(10) Pub. No.: US 2017/0013808 A1
(43) Pub. Date: Jan. 19, 2017

(54) Invisi-Gate

(71) Applicants: Laura Lee Leavenworth, White Lake, MI (US); Jonathan Robbins, Lake, MI (US)

(72) Inventors: Laura Lee Leavenworth, White Lake, MI (US); Jonathan Robbins, Lake, MI (US)

(21) Appl. No.: 14/799,505

(22) Filed: Jul. 14, 2015

(51) Int. Cl. A01K 27/00; H04W 4/00; A01K 11/00

(52) U.S. Cl. CPC A01K 27/009; A01K 11/008; A01K 27/001; H04W 4/008

(57) ABSTRACT

The disclosed herein is a method of using radio frequency identification (RFID), in is described, which keeps pets from accessing household objects. The pet wears a device on neck which is preferably powered by the animal's own activity, converted to electrical power by a motion harvesting system to recharge a battery or standard lithium battery Because the RFID tags are individually identifiable, the forbidden area alarm can be configured to the pet, allowing use in a multiple-pet household.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The invention pertains to the field of animal training to keep them away from house objects or others. More particularly, the invention pertains to animals to remain in or avoid a selected area using wireless alarm devices.

(2) Background

Animal stewards often want to confine animals to a particular area without having to erect physical barriers, such as GATES or fences. Reasons for controlling animal movement range from protecting furniture to safety concerns, such as protecting the animal from unauthorized entrance/exit or accessing cupboards where harmful domestic cleaning products may be stored or harming themselves on dangerous objects.

Heretofore, omnidirectional wireless radio transmitters have been set out in regions to be protected from grazing by animals. The animal wore battery powered radio receivers attached to their ears or worn as a collar around their necks. Audio and electric stimuli were administered to the animal in response to receiving a signal exceeding a certain threshold level.

Pet confinement systems often include a radio frequency transmitter having a wire loop for transmitting the radio frequency signal. The wire loop antenna roughly defines the boundary in which the animal is to be confined. The animal wears a receiving unit that is attached to its collar. If the animal gets within a predetermined distance of the wire loop antenna, the receiver unit detects the radio frequency signal transmitted from the loop antenna, whereupon a correcting stimulus such as an electrical shock is applied to the animal. A problem is that it is difficult and time consuming to lay the ground loop antenna. If a discontinuity in the wire loop antenna occurs, it is then necessary to locate and repair the discontinuity. Furthermore, once the wire loop antenna is laid into the ground, the boundaries of the animal's confinement area are fixed, and cannot be easily modified.

It is also known to use a wireless system to track a target, e.g., an article, animal or person. One such wireless system transmits an ultrasound signal to a receiver unit carried by the animal. In response to receiving the ultrasound signal, the receiver unit transmits a radio frequency signal back to the transmitter of the ultrasound signal. Since the speed of sound is known, and radio frequency signals travel practically instantaneously at the speed of light, the transmitting unit can calculate how far away from the transmitter the receiving unit is located based upon the time interval between transmitting the ultrasound signal and receiving the radio frequency signal. If that time interval exceeds a predetermined threshold, indicating that the receiving unit is further than a threshold distance away from the transmitting unit, a second radio frequency signal is transmitted from the transmitting unit to the receiving unit. Upon receiving the second radio frequency signal, the receiving unit applies a correcting stimulus to the animal. U.S. Pat. No. 4,898,120 to Brose sets forth a more sophisticated system in which the parameters of an area in which an animal are to be restrained are determined by evaluating a signal received by a central receiver sent from a transmitter on the animal. This central unit may then transmit a signal to a device worn by the animal to generate a warning shock, sound, visual or the like. However, a new method of implementing an RFID reader has recently been described in GB0525622.7, GB0525624.3, and GB0611243.7. This new method among other things allows the use of a high efficiency antenna, whilst maintaining sufficient communication bandwidth to determine the identification number of the RFID tag. This is in contrast to a standard reader where the antenna efficiency is inversely related to the communication bandwidth and hence the efficiency has an upper limit.

It would be desirable to provide a system using wireless transmitters that is readily portable, if desired, and more approximate results would obtained by ordinary wire fencing.

### BRIEF SUMMARY OF THE INVENTION

The present invention provides a wireless animal confinement method and system which solves one or more the listed shortcomings of the prior methods and systems.

In one embodiment, the present invention is a method of using radio frequency identification (RFID) is described, which keeps pets from accessing forbidden areas. The pet wears a device on collar which is preferably powered by the animal's own activity, converted to electrical power by a motion harvesting system to recharge a battery or rechargeable lithium battery or the like.

In another embodiment, the device uses an RFID tag and an RFID reader to detect and identify sensors placed at the areas to which the pet is forbidden to enter, and warns the pet through an alarm device if it is approaching such an area. Because the RFID tags are individually identifiable, the forbidden area can be configured to the pet, allowing use in a multiple-pet household. Multiple sensors could be configured to be used as a ‘playpen’ type enclosure. According to the invention the RFID tag is attached to at least one sensor.

It is the objective of the current invention to provide a device of this invention that includes radio transmitter sensors and radio receiver and a control box. The control box will set correction strength and warning distances as well as detect low batteries and zones. Further control box communicates a warning based on communication of the radio transmitter and/or the radio receiver. The sensors would be compacting as possible as can be fit in doorways and windows etc.

In one aspect of the invention an electronic pet containment system is provided that comprising of lithium battery that supplies electrical power to the control box, sensors, RFID reader and the alarm. The control box is 4×6 inch and the control box communicates a warning based on communication of said radio transmitter and/or said radio receiver. The control box is for turning on/off zones, adjusting volume, visual control, warning distances, stimulating or lowing batteries in sensors or collar. The visual control is a red laser beam that defines the boundary line of the area where the pet is trained to stay in or the area from where the pet is trained to stay away from. As a pet carrying the collar having the RFID tag crosses the line stimulation is created by the collar to hit the pet.

The summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a 3D Photo frame design according to a preferred embodiment of the present invention.

### DETAILED DESCRIPTIONS OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

In a preferred embodiment, the invention is a wireless pet containment system, programmable boundary that is provided for tracking the movement of animals, humans and like moving objects. In one aspect, the system has a transmitter that creates an adjustable circular field, pertaining to which if an animal travels outside the boundary of that field; the animal receives a stimulation teaching it to act in a specific way, for example if a dog wearing the system goes out of a confined boundary of the system it receives a stimulation like a mild shock teaching him to stay inside the field. Objects detected as venturing beyond the programmed boundaries are subject to a correction stimulus, such as a mild shock or audible signal, delivered to the object by the relay collar when enabled by the RF transmissions of the remotely located processing station.

Further the pet containment systems maintains animal within a defined area or to keep the animal outside of a defined area. The system includes a buried antenna wire which has a defined perimeter or boundary across which the animal or other pet is trained to not cross. The device provided the wireless pet containment system generating an electromagnetic field defining a containment boundary for confining a pet wearing a stimulus module collar that is responsive to the electromagnetic field. While the system is described herein as it would be used in a house, it will be understood that the system can be used both indoors and outdoors.

The present invention facilitates training, tracking, and monitoring animals. In particular, the invention provides a system and method for wirelessly controlling a collar or similar device attached to an animal. Moreover the invention includes a control box having radio transmitter and radio receiver, a collar fix with RFID tag, an alarm device and a small lithium battery. The device uses an RFID reader to detect and identify sensors placed at the areas to which the pet is forbidden to enter, and warns the pet through an alarm device if it is approaching such an area. Because the RFID tags are individually identifiable, the forbidden area can be configured to the pet, allowing use in a multiple-pet household. The RFID tag is usually made of several lightest and most durable materials, within which the components are embedded or encapsulated.

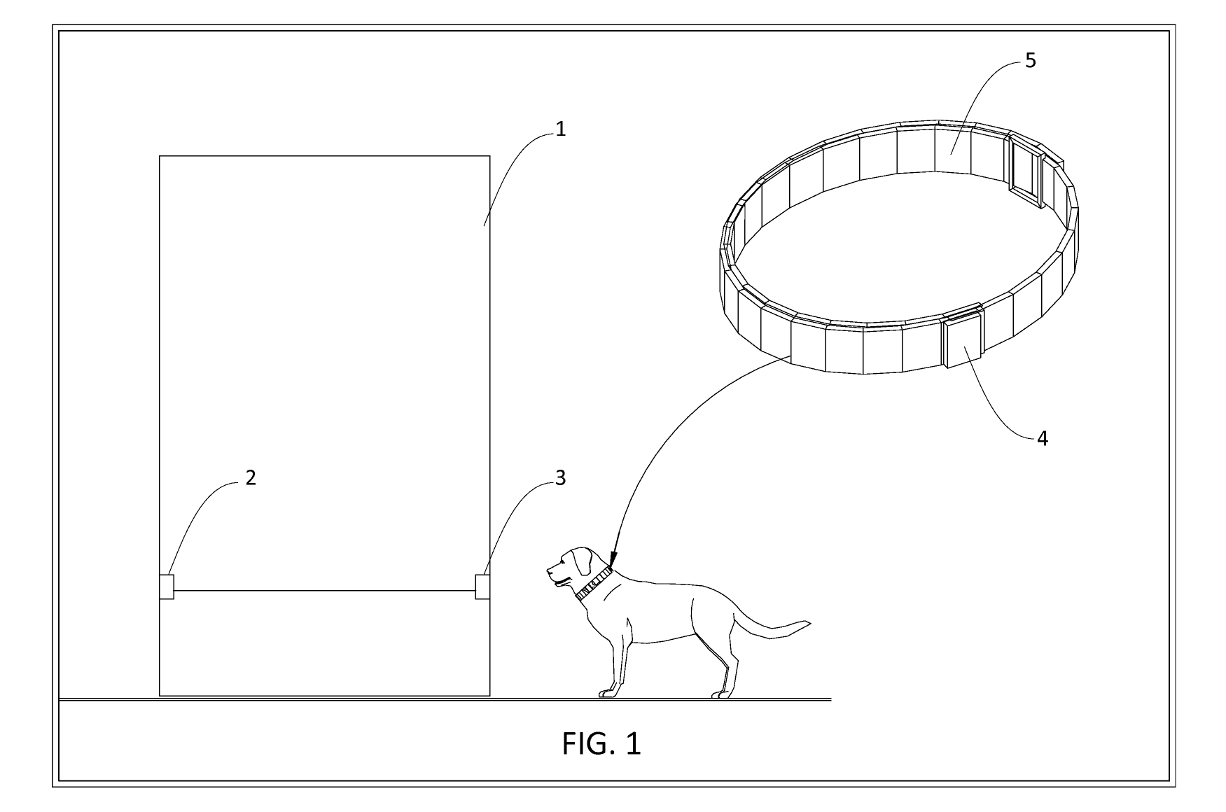

Referring now to the drawings and particularly to FIG. 1, a wireless pet confinement system of the present invention includes a control box 1 having radio transmitter 2 and radio receiver 3 fixed inside of the control box. The RFID tag 4 is fixed with collar 5 on animal neck. When RFID reader detects the sensors placed at the areas to which the pet is forbidden to enter, the collar gets triggered and warns the pet through a store like alarm if it is approaching such an area. It is to be understood that the above description is intended to be illustrative, and not restrictive. For example, the above-discussed embodiments may be used in combination with each other. Many other embodiments will be apparent to those of skill in the art upon reviewing the above description. It is to be understood that the above description is intended to be illustrative, and not restrictive. For example, the above-discussed embodiments may be used in combination with each other. Many other embodiments will be apparent to those of skill in the art upon reviewing the above description.

The control box is 4×6 inch and the control box communicates a warning based on communication of said radio transmitter and/or said radio receiver. The control box is for turning on/off zones, adjusting volume, visual control, warning distances, stimulating or lowing batteries in sensors or collar. The visual control is a red laser beam that defines the boundary line of the area where the pet is trained to stay in or the area from where the pet is trained to stay away from. As a pet carrying the collar having the RFID tag crosses the line stimulation is created by the collar to hit the pet.

The present invention provides a wireless animal confinement method that uses radio frequency identification (RFID) that keeps pets from accessing forbidden areas. The pet wears a device on collar which is preferably powered by the animal's own activity, converted to electrical power by a motion harvesting system to recharge a battery or rechargeable lithium battery or the like. The device uses an RFID reader to detect and identify sensors placed at the areas to which the pet is forbidden to enter, and warns the pet through an alarm device if it is approaching such an area. Because the RFID tags are individually identifiable, the forbidden area can be configured to the pet, allowing use in a multiple-pet household. Multiple sensors could be configured to be used as a ‘playpen’ type enclosure. The device of this invention includes radio transmitter sensors and radio receiver and a control box. The control box will set correction strength and warning distances as well as detect low batteries and zones. The sensors would be fit in doorways and windows etc.

Plural instances may be provided for components, operations or structures described herein as a single instance. Finally, boundaries between various components are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

Although the invention has been explained in relation to its preferred embodiment, it is to be understood that many other possible modifications and variations can be made without departing from the spirit and scope of the invention.

We claim:

1. An electronic pet containment system for selectively providing access to a site within a control area, the system comprising:
a control box;
a collar;
RFID tag;
sensors;
RFID reader;
an alarm; and
a lithium battery.

2. The electronic pet containment system as in claim 1, wherein said control box comprises a radio transmitter and/or a radio receiver.

3. The electronic pet containment system as in claim 1, wherein at least one said sensor having transmitter.

4. The electronic pet containment system as in claim 1, wherein at least one said sensor having receiver.

5. The electronic pet containment system as in claim 1, wherein said alarm is coupled to an output of at least one said sensor.

6. The electronic pet containment system as in claim 1, wherein said alarm is coupled to said collar.

7. The electronic pet containment system as in claim 1, wherein said collar is secured on animal's neck.

8. The electronic pet containment system as in claim 1, wherein said RFID tag is attached to the collar.

9. The electronic pet containment system as in claim 1, wherein said lithium battery supplies electrical power at least to the control box, said sensors, said RFID reader and said alarm.

10. The electronic pet containment system as in claim 1, wherein said RFID tag is attached to at least one said sensors.

11. The electronic pet containment system as in claim 1, wherein dimension of said control box is 4×6 inch.

12. The electronic pet containment system as in claim 1, wherein said control box communicates a warning based on communication of said radio transmitter and/or said radio receiver.

13. The electronic pet containment system as in claim 1, wherein said control box is for turning on/off zones, adjusting volume, visual control, warning distances, stimulating or lowing batteries in sensors or collar.

14. The electronic pet containment system as in claim 1, wherein said control box controls said visual control.

15. The electronic pet containment system as in claim 13, wherein said visual control is a red laser beam.

16. The electronic pet containment system as in claim 1, wherein said sensors having built in radio transmitter, receivers, well as visual, alarm, and warning distances.

17. The electronic pet containment system as in claim 1, wherein dimension of said control box vary based on the size necessary to house components.

18. A method of applying at least one of a stimulus and a warning signal to an animal, said method comprising the steps of:
selecting a distance value between the animal and a transmitter;
transmitting a radio frequency signal from said transmitter at a first point in time; and
receiving, at a time substantially equal to said first point in time, said radio frequency signal with a receiver attached to the animal.
